(19) United States
(12) Patent Application Publication
(10) Pub. No.: US 2026/0309303 A1
(43) Pub. Date: Oct. 8, 2026

(54) LAMP WITH TRANSPARENT ANTI-GLARE DUAL-LENS STRUCTURE

(71) Applicant: Zhongshan Zuodeng Lighting and Electrical Co., Ltd., Zhongshan City (CN)

(72) Inventor: Haihua LV, Zhongshan City (CN)

(73) Assignee: Zhongshan Zuodeng Lighting and Electrical Co., Ltd., Zhongshan City (CN)

(21) Appl. No.: 19/638,144

(22) Filed: Apr. 3, 2026

Related U.S. Application Data
(63) Continuation of application No. PCT/CN2026/082743, filed on Mar. 11, 2026.

(30) Foreign Application Priority Data
Apr. 3, 2025 (CN) 202520635743X

(51) Int. Cl. F21V 5/00; F21V 7/04

(52) U.S. Cl. CPC F21V 5/004; F21V 7/04

(57) ABSTRACT

Disclosed in this disclosure is a lamp with a transparent anti-glare dual-lens structure, including a housing and a lamp panel, a first transparent lens, and a second transparent lens that are sequentially disposed in the housing. One side of each of the first transparent lens and the second transparent lens close to the lamp panel is a light incident surface, and the other side is a light exit surface. Prismatic micro lens arrays are disposed on the light exit surface of the first transparent lens and the light exit surface of the second transparent lens respectively, and shapes of prismatic micro lenses on the first transparent lens and the second transparent lens are different. Light emitted by the lamp with a transparent anti-glare dual-lens structure of this disclosure is uniform, avoiding high-intensity direct anti-glare, and a light exit angle can be adjusted within a range of 10° to 90°.

### CROSS-REFERENCE TO RELATED APPLICATIONS

The application claims priority to Chinese patent application No. 202520635743X, filed on Apr. 3, 2025, the entire contents of which are incorporated herein by reference.

### TECHNICAL FIELD

This disclosure relates to the technical field of lighting devices, and specifically to a lamp with a transparent anti-glare dual-lens structure.

### BACKGROUND

Traditional bulbs adopt either transparent or milky-white lampshades. With transparent lampshades, which are both light-transmitting and transparent, the human eyes can directly perceive the glowing lamp beads while the bulbs are in operation; the light emitted by these lamp beads can easily irritate the human eyes, thereby inducing visual fatigue. To solve the above problems, bulbs adopting milky-white lampshades have emerged on the market. These milky-white lampshades can enable light to diffuse into the space more softly and uniformly and prevent the generation of harsh and glaring light, thereby protecting the eyes. However, compared with transparent lampshades, the milky-white lampshades are non-transparent. Light tends to linger on the milky-white lampshades, resulting in significant loss of light effects and a certain degree of glare. Consequently, milky-white lampshades reduce the amount of light emitted by the bulbs, thereby lowering the illuminance of the illuminated objects.

### SUMMARY

This disclosure aims to at least solve one of the technical problems existing in the prior art. Therefore, this disclosure provides a lamp that can not only enable light to diffuse into space more softly and uniformly to achieve an anti-glare effect, but also avoid affecting brightness. The adopted technical solutions include:

A lamp with a transparent anti-glare dual-lens structure, including a housing provided with a light-emitting cavity and a lamp panel, a first transparent lens, and a second transparent lens that are sequentially disposed in the housing, where one side of each of the first transparent lens and the second transparent lens close to the lamp panel is a light incident surface, the other side is a light exit surface, transparent prismatic micro lens arrays are disposed on the light exit surface of the first transparent lens and the light exit surface of the second transparent lens respectively, and shapes of prismatic micro lenses on the first transparent lens and the second transparent lens are different.

To solve the technical problem, an embodiment of this disclosure adopts a technical solution: a reflective cup is further included, and the reflective cup is disposed in the housing and distributed between the lamp panel and the first transparent lens.

To solve the technical problem, an embodiment of this disclosure adopts a technical solution: a Fresnel structure, a fly-eye transparent lens structure, or a compound-eye transparent lens structure is disposed on the light incident surface of the first transparent lens and/or the light incident surface of the second transparent lens.

To solve the technical problem, an embodiment of this disclosure adopts a technical solution: a Hartmann array is further disposed on the light incident surface of the second transparent lens.

To solve the technical problem, an embodiment of this disclosure adopts a technical solution: the shapes of the transparent prismatic micro lenses are square, rhombic, circular, polygonal, or elliptical.

To solve the technical problem, an embodiment of this disclosure adopts a technical solution: materials of the first transparent lens and the second transparent lens are transparent plastic, transparent soft silicone, or transparent glass.

Beneficial effects of this disclosure are as follows:

Light emitted by lamp beads on the lamp panel is incident on the prismatic micro lens array of the first transparent lens, and then undergoes multiple reflections and refractions, generating light path oscillation and changing the light direction before being emitted to the second transparent lens. The light emitted to the second transparent lens again undergoes multiple reflections and refractions, generating light path oscillation and changing the light direction before being emitted. The surface microstructure design scatters the light, and different shapes of prismatic micro lens arrays generate different light effects after the reflection and refraction of the beams. Therefore, by using the synergistic effects produced by the prismatic micro lenses on the first transparent lens and the second transparent lens on the beams, the uniformity of the emitted light is ensured, thereby avoiding high-intensity direct anti-glare, preventing naked eyes from directly observing the light-emitting lamp beads from the outside of the lamp, and implementing anti-glare; and by using the total reflection of the first transparent lens and the second transparent lens, the light loss is reduced, and the brightness is ensured.

The phase gradient of the prismatic micro lenses can directionally deflect the sub-beams, for example, concentrating the light onto a specific region, thereby ensuring the brightness while reducing invalid scattered light. Further, by adjusting the shape design of the first transparent lens and the second transparent lens, a light exit angle of the lamp with a transparent anti-glare dual-lens structure can be adjusted within a range of 10° to 90°.

### BRIEF DESCRIPTION OF THE DRAWINGS

The above and/or additional aspects and advantages of this disclosure will become apparent and easy to understand from the description of the embodiments in conjunction with the following accompanying drawings, where:

FIG. 1 is a structural exploded view 1 of a lamp with a transparent anti-glare dual-lens structure according to an embodiment; and

FIG. 2 is a structural exploded view 2 of a lamp with a transparent anti-glare dual-lens structure according to an embodiment.

### DETAILED DESCRIPTION OF THE EMBODIMENTS

This part will describe the specific embodiments of this disclosure in detail. The preferred embodiments of this disclosure are shown in the accompanying drawings, and the function of the accompanying drawings is to supplement the description of the text part of the specification with graphics, which enables people to intuitively and vividly understand each technical feature and the overall technical solutions of this disclosure, but cannot be understood as limiting the protection scope of this disclosure.

In the description of this disclosure, “a plurality of” means more than two, “greater than a number”, “less than a number”, “exceed a number” and the like indicate that the number is excluded, and “above a number”, “below a number”, “within a number”, and the like indicate that the number is included. “First” and “second” are intended only for distinguishing between technical features but cannot be used to indicate or imply relative importance or implicitly specify a quantity of indicated technical features or implicitly specify a sequential relationship of indicated technical features.

In the description of this disclosure, it should be understood that the positional descriptions referred to, for example, the directional or positional relationships indicated by up, down, front, rear, left, right, etc., are based on the directional or positional relationships shown in the drawings, and are only for convenience and simplification of description of this disclosure, but not for indicating or implying that the referred device or element must have a specific direction, be constructed and operated in a specific direction, and thus should not be construed as limiting this disclosure.

In this disclosure, unless otherwise expressly defined, the terms such as “dispose”, “mount”, and “connect” should be understood in a broad sense. For example, it can be directly connected or indirectly connected through intermediate media; it can be in a fixed connection, a detachable connection, or an integrated molding; it can be in a mechanical connection; and it can be internal connectivity of two elements or an interaction relationship between two elements. For those of ordinary skill in the art, specific meanings of the terms in this disclosure may be appropriately determined with reference to the specific content in the technical solution.

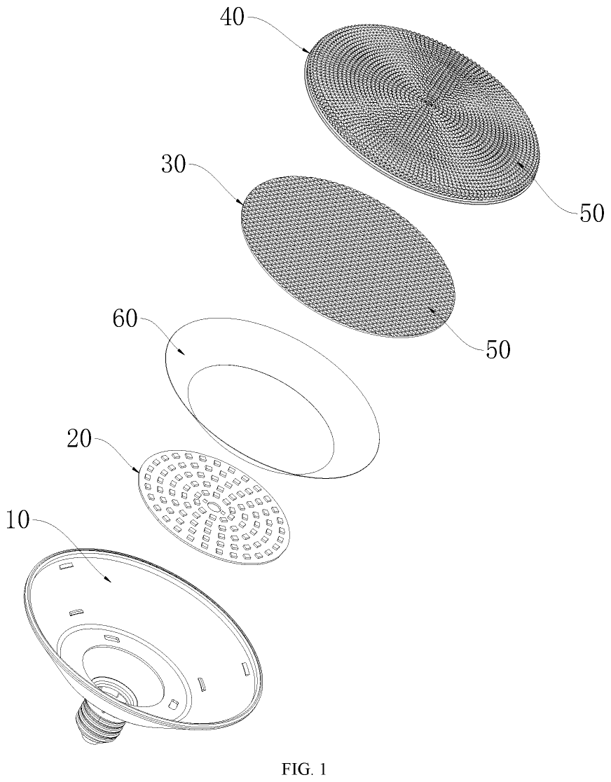

Referring to FIG. 1, an embodiment of this disclosure is provided. This embodiment provides a lamp with a transparent anti-glare dual-lens structure, including a housing 10 provided with a light-emitting cavity and a lamp panel 20, a first transparent lens 30, and a second transparent lens 40 that are sequentially disposed in the housing 10. One side of each of the first transparent lens 30 and the second transparent lens 40 close to the lamp panel 20 is a light incident surface, and the other side is a light exit surface. Prismatic micro lens arrays 50 are disposed on the light exit surface of the first transparent lens 30 and the light exit surface of the second transparent lens 40 respectively, and shapes of prismatic micro lenses on the first transparent lens 30 and the second transparent lens 40 are different.

Light emitted by lamp beads on the lamp panel 20 is incident on the prismatic micro lens array 50 of the first transparent lens 30, and then undergoes multiple reflections and refractions, generating light path oscillation and changing the light direction before being emitted to the second transparent lens 40. The light emitted to the second transparent lens 40 again undergoes multiple reflections and refractions, generating light path oscillation and changing the light direction before being emitted. The surface microstructure design scatters the light, and different shapes of prismatic micro lens arrays 50 generate different light effects after the reflection and refraction of beams. Therefore, by using the synergistic effects produced by the prismatic micro lenses on the first transparent lens 30 and the second transparent lens 40 on the beams, the uniformity of the emitted light is ensured, thereby avoiding high-intensity direct anti-glare, preventing naked eyes from directly observing the light-emitting lamp beads from the outside of the lamp, and implementing anti-glare; and by using the total reflection of the first transparent lens 30 and the second transparent lens 40, the light loss is reduced, and the brightness is ensured.

The phase gradient of the prismatic micro lenses can directionally deflect the sub-beams, for example, concentrating the light onto a specific region, thereby ensuring the brightness while reducing invalid scattered light. Further, by adjusting the shape design of the first transparent lens 30 and the second transparent lens 40, a light exit angle of the lamp with a transparent anti-glare dual-lens structure can be adjusted within a range of 10 to 90°.

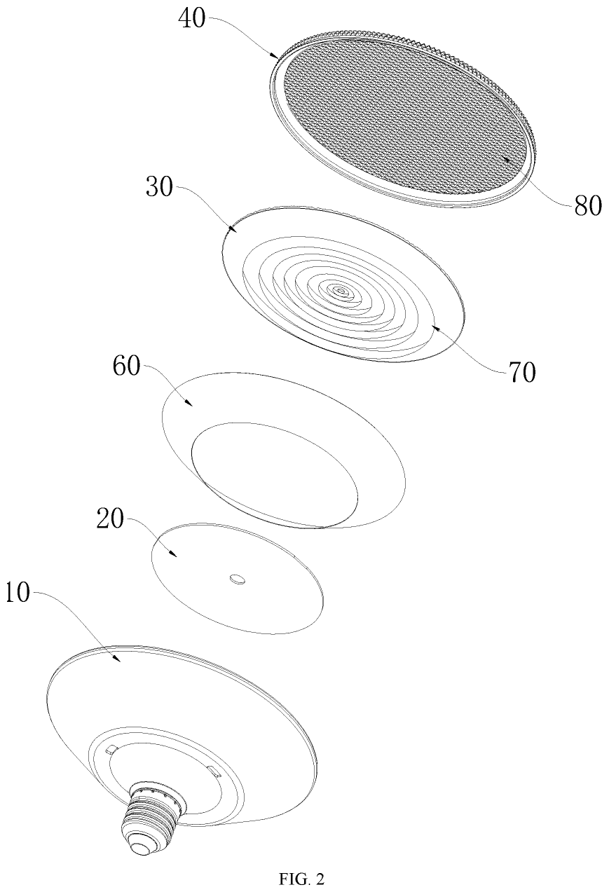

The lamp with a transparent anti-glare dual-lens structure of this disclosure may be applied to a bulb lamp, implementing anti-glare while improving the brightness of the bulb lamp. In addition, it may also be applied to a UFO lamp, as shown in FIG. 1 and FIG. 2. It may also be applied to a lamp requiring high illumination intensity at a specific angle, such as a wall lamp, a mirror lamp, an office lamp, a home lamp, a strip lamp, a commercial engineering lamp, and an outdoor tri-proof lamp.

Preferably, in this disclosure, a reflective cup 60 is disposed between the lamp panel 20 and the first transparent lens 30. The light within a certain range emitted by the lamp beads on the lamp panel 20 is reflected by the reflective cup 60, so that the scattered light emitted by the array lamp beads is concentrated to form more directional beams, reducing the divergence of the light and helping improve the light intensity and illumination distance. In addition, when designing a light exit range of the lamp, by adjusting the curvature and depth of the reflective cup 60, a diffusion angle of the beams can be changed, thereby adjusting the light exit range of the lamp from narrow to wide.

A Fresnel structure 70, a fly-eye transparent lens structure, or a compound-eye transparent lens structure may further be disposed on the light incident surface of the first transparent lens 30 and/or the light incident surface of the second transparent lens 40.

After illuminating the reflective cup 60 and being reflected, the light is collimated and illuminated on the first transparent lens 30. Based on this, preferably, the Fresnel structure 70, the fly-eye transparent lens structure, or the compound-eye transparent lens structure may further be disposed on the light incident surface of the first transparent lens 30 and/or the light incident surface of the second transparent lens 40. The Fresnel structure 70, the fly-eye transparent lens structure, or the compound-eye transparent lens structure can concentrate the light, which helps improve the illumination brightness.

In this embodiment, the Fresnel structure 70 is disposed on the light incident surface of the first transparent lens 30. As shown in FIG. 2, on the premise that the Fresnel structure 70 is disposed on the light incident surface of the first transparent lens 30, a Hartmann array 80 may further be disposed on the light incident surface of the second transparent lens 40, preventing the light emitted by the lamp panel from diverging too much and causing the Hartmann array 80 to fail to work effectively. The Fresnel structure 70 collimates the light from the bulb to form parallel light. After the parallel light is illuminated on the Hartmann array 80 disposed on the light incident surface of the second transparent lens 40, the Hartmann array 80 divides the beams through micro lenses, which decomposes the light with a large divergence angle into a plurality of sub-beams, and forms a regular spot array through focusing, further homogenizing the light intensity distribution. Then, through the prismatic micro lenses on the light exit surface of the second transparent lens 40, the light path is oscillated, and the sub-beams are directionally deflected before being emitted, achieving light exit in the range of 10° to 90° and reducing uneven brightness.

Materials of the first transparent lens 30 and the second transparent lens 40 are not specifically limited in this disclosure, which may be transparent plastic, transparent soft silicone, or transparent glass.

In this disclosure, the shapes of the prismatic micro lenses are square, rhombic, circular, polygonal, or elliptical. To achieve different light effects, the shapes of the prismatic micro lenses can be adjusted, for instance, hexagonal micro lenses may ensure uniform light distribution and widen the illumination angle, square micro lenses may control horizontal or vertical diffusion angles of the lamp, and circular micro lenses may form soft and circular light spots.

Certainly, this disclosure is not limited to the above implementations. Those skilled in the art may also make equivalent modifications or replacements without departing from the spirit of this disclosure. These equivalent modifications and replacements all fall within the scope of the claims of this disclosure.

What is claimed is:

1. A lamp with a transparent anti-glare dual-lens structure, comprising a housing (10) provided with a light-emitting cavity and a lamp panel (20), a first transparent lens (30), and a second transparent lens (40) that are sequentially disposed in the housing (10), wherein one side of each of the first transparent lens (30) and the second transparent lens (40) close to the lamp panel (20) is a light incident surface, the other side is a light exit surface, transparent prismatic micro lens arrays (50) are disposed on the light exit surface of the first transparent lens (30) and the light exit surface of the second transparent lens (40) respectively, and shapes of prismatic micro lenses on the first transparent lens (30) and the second transparent lens (40) are different.

2. The lamp with a transparent anti-glare dual-lens structure according to claim 1, further comprising a reflective cup (60), wherein the reflective cup (60) is disposed in the housing (10) and distributed between the lamp panel (20) and the first transparent lens (30).

3. The lamp with a transparent anti-glare dual-lens structure according to claim 1, wherein a Fresnel structure (70), a fly-eye transparent lens structure, or a compound-eye transparent lens structure is disposed on the light incident surface of the first transparent lens (30) and/or the light incident surface of the second transparent lens (40).

4. The lamp with a transparent anti-glare dual-lens structure according to claim 3, wherein a Hartmann array (80) is further disposed on the light incident surface of the second transparent lens (40).

5. The lamp with a transparent anti-glare dual-lens structure according to claim 1, wherein the shapes of the prismatic micro lenses are square, rhombic, circular, polygonal, or elliptical.

6. The lamp with a transparent anti-glare dual-lens structure according to claim 1, wherein materials of the first transparent lens (30) and the second transparent lens (40) are transparent plastic, transparent soft silicone, or transparent glass.
